(19) United States
(12) Patent Application Publication
(10) Pub. No.: US 2021/0199245 A1
(43) Pub. Date: Jul. 1, 2021

(54) METHOD FOR INCREASING PUMP NET POSITIVE SUCTION HEAD

(71) Applicant: L'Air Liquide, Societe Anonyme pour l'Etude et l'Exploitation des Procedes Georges Claude, Paris (FR)

(72) Inventors: Paul KONG, Sugar Land, TX (US); Minh Huy PHAM, Houston, TX (US)

(73) Assignee: L'Air Liquide, Societe Anonyme pour l'Etude et l'Exploitation des Procedes Georges Claude, Paris (FR)

(21) Appl. No.: 16/731,022

(22) Filed: Dec. 30, 2019

(51) Int. Cl. F17C 9/00; F04B 15/06; F04B 23/02

(52) U.S. Cl. CPC F17C 9/00; F04B 15/06; F04B 23/02; F04B 2205/01; F17C 2250/061; F17C 2250/0626; F17C 2227/0135

(57) ABSTRACT

A method for increasing the available net positive suction head (NPSHa) for a cryogenic pump is provided. In one embodiment, the method can include the steps of: increasing a pressure within a liquid storage tank to at least a pumping set point, wherein the pumping set point is configured to cause the NPSHa to exceed the NPSHr; starting the cryogenic pump, thereby sending liquid from within the liquid storage tank through the pump and to an end user; stopping the cryogenic pump, thereby stopping flow of the liquid from the liquid storage tank; and resetting the pressure within the liquid storage tank to at least a storage set point.

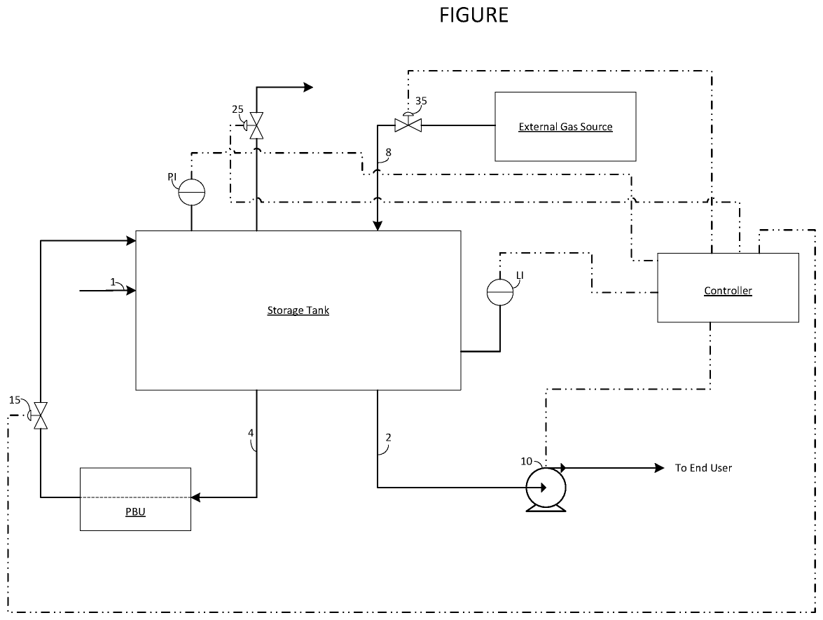

### TECHNICAL FIELD

The present invention generally relates to a method for improving pump available net positive suction head (NPSHa) in a system for pumping liquid that is at near its boiling point, particularly, cryogenic liquid.

### BACKGROUND OF THE INVENTION

A pump is often used to transfer cryogenic liquid between the storage vessels or increase the liquid pressure for vaporization in a backup system. For proper operation, each pump requires a net positive suction head (NPSHr), which is the equivalent to total head of liquid less the vapor pressure. In an installation, the NPSHa must be greater than NPSHr to warrant a safe and successful pump operation. If the NPSHa is not adequate, the pump can cavitate and cause damage to the pump. Cryogenic liquid in the vessel is at or near its boiling point, and therefore, has a low NPSHa. This makes pumps used in cryogenic settings more vulnerable to cavitation, especially, if the liquid level in the tank is low.

A conventional way to resolve this problem is either to elevate tank to a higher elevation resulting in higher installation cost, or the pump must be stopped prematurely resulting in reduction of usable storage capacity. Therefore, it would be advantageous to have an economical solution that did not require increasing the elevation of the storage tank, and could also work in the event of lower liquid levels.

### BRIEF SUMMARY OF THE INVENTION

The present invention is directed to a device and a method that satisfies at least one of these needs. Certain embodiments of the present invention relate to a method for improving pump available net positive suction head (NPSHa) in a system for pumping liquid that is at or near its boiling point, particularly, cryogenic liquid.

Cryogenic liquid in a storage tank is usually saturated (i.e., at its boiling point) at the tank vapor pressure at steady state (i.e., when the pressure in the tank is held constant for a long time). However, when the tank vapor pressure is increased momentarily, the liquid in the tank will become temporarily subcooled for a period of time before the liquid temperature increases to reach the new equilibrium again at higher pressure due to the heat leak from the ambient. Consequently, NPSHa is increased accordingly during this transient period. Certain embodiments of the present invention make use of this transient phenomenon of the liquid in the tank to temporarily increase pump NPSHa.

Certain embodiments of the present invention provide a simple and more cost-effective method of temporarily increasing the NPSHa by increasing the vapor pressure in the tank. It can be uniquely applied to a liquid transfer and backup system operation, as they are usually batch processes. In certain embodiments, the pressure can be regulated (reset) back to its original set value once pumping operation is finished. In certain embodiments, the pressure source can be either through an internal pressure builder or from an externally provided gas. The regulation of the tank pressure can be fully automated in conjunction with an automatic pump start/stop sequence.

In one embodiment, depending on the actual system requirement, a pump start sequence can be as follows:
pump cool down if not in cold standby state;
bump the tank pressure to a higher value;
pump start;
optional ramp up of the tank pressure as tank level drops in order to compensate for the decrease in liquid head;
optional increase in tank pressure if there is an indication of low liquid level in the tank;
pump stop and then reset the pressure to the original set point; and
excess pressure can be vented through vent control valve or can be used in an optional economizer system (not shown).

In one embodiment, a method for increasing the available net positive suction head (NPSHa) for a cryogenic pump is provided. In one embodiment, the method can include the steps of: increasing a pressure within a liquid storage tank to at least a pumping set point, wherein the pumping set point is configured to cause the NPSHa to exceed the NPSHr; starting the cryogenic pump, thereby sending liquid from within the liquid storage tank through the pump and to an end user; stopping the cryogenic pump, thereby stopping flow of the liquid from the liquid storage tank; and resetting the pressure within the liquid storage tank to at least a storage set point.

In optional embodiments of the method for increasing the NPSHa of the cryogenic pump:
the step of increasing the pressure within the liquid storage tank further comprises sending a pressurized gas from an external gas source into a headspace of the liquid storage tank;
the step of increasing the pressure within the liquid storage tank further comprises withdrawing fluid from the liquid storage tank and introducing said liquid into a pressure building unit that is configured to increase the pressure of the fluid, and then introducing said fluid at an increased pressure to the liquid storage tank, thereby increasing the pressure within the liquid storage tank;
the method can also include the step of cooling the cryogenic pump prior to the step of starting the cryogenic pump;
the method can also include the step of further maintaining the pressure within the liquid storage tank at the pumping set point while the cryogenic pump is operating in order to compensate for head losses due to lower liquid levels;
the method can also include the step of measuring a liquid level within the liquid storage tank;
the method can also include the step of immediately increasing the pressure within the liquid storage tank upon a determination that the liquid within the liquid storage tank is below a liquid level threshold; and/or
the step of resetting the pressure within the liquid storage tank comprises venting gas from a headspace of the liquid storage tank after stopping the cryogenic pump.

The foregoing has outlined rather broadly the features and technical advantages of the present invention in order that the detailed description of the invention that follows may be better understood. Additional features and advantages of the invention will be described hereinafter which form the subject of the claims of the invention. It should be appreciated by those skilled in the art that the conception and specific embodiment disclosed may be readily utilized as a basis for modifying or designing other structures for carrying out the same purposes of the present invention. It should also be realized by those skilled in the art that such equivalent constructions do not depart from the spirit and scope of the invention as set forth in the appended claims. The novel features, which are believed to be characteristic of the invention, both as to its organization and method of operation, together with further objects and advantages will be better understood from the following description when considered in connection with the accompanying figures. It is to be expressly understood, however, that each of the figures is provided for the purpose of illustration and description only and is not intended as a definition of the limits of the present invention.

### BRIEF DESCRIPTION OF THE DRAWINGS

For a more complete understanding of the present invention, reference is now made to the following descriptions taken in conjunction with the accompanying drawings, in which:

The FIGURE is a process flow diagram of an embodiment of the present invention.

### DETAILED DESCRIPTION OF THE INVENTION

Referring to the FIGURE, the apparatus can include a storage tank, a pump 10, a pressure building unit (PBU), a process controller, an external gas source, a pressure indicator (PI), a liquid level indicator (LI), and a plurality of control valves 15, 25, 35.

In the embodiment shown, the controller is in communication with the pressure indicator and the liquid level indicator. Based on these measurements, the controller can determine if the NPSHa for liquid in the storage tank is greater than the NPSHr of pump 10. If the NPSHa needs to be increased, then the controller can send a signal to either valve 15 or valve 35 to open.

If valve 15 is opened, then fluid from storage tank flows via line 4 into the PBU, wherein the fluid is pressurized, and fed back into the storage tank, thereby increasing the vapor pressure within the storage tank. If valve 35 is opened, then a pressurized external gas flows from the external gas source and into the storage tank via line 8. Once the NPSHa is above an acceptable threshold, the respective valves can be closed.

Once the controller determines that the NPSHa is suitable, liquid from the storage tank is withdrawn via line 2 and sent to an end user. In an optional embodiment, if the NPSHa drops below the threshold during withdrawal of the liquid product, the controller can send signals to valves 15 and 35 to open until the NPSHa is above the threshold. This is particularly useful as the liquid level within the tank gets lower, wherein a low level indication can automatically trigger an opening of valves 15, 35.

When the end user no longer needs the liquid product, the pump 10 is stopped. If the pressure within the storage tank is too high, then controller can open vent valve 25 so that excess vapor can exit the storage tank via line 12. Fresh liquid product 1 is introduced into storage tank.

As used herein—cryogenic fluid is meant to encompass any fluid that is at a temperature of less than −50° C. As used herein—a temperature that is “close to” or “about” is the same as or within 5° C. of the referenced temperature.

Although the present invention and its advantages have been described in detail, it should be understood that various changes, substitutions and alterations can be made herein without departing from the spirit and scope of the invention as defined by the appended claims. Moreover, the scope of the present application is not intended to be limited to the particular embodiments of the process, machine, manufacture, composition of matter, means, methods and steps described in the specification. As one of ordinary skill in the art will readily appreciate from the disclosure of the present invention, processes, machines, manufacture, compositions of matter, means, methods, or steps, presently existing or later to be developed that perform substantially the same function or achieve substantially the same result as the corresponding embodiments described herein may be utilized according to the present invention. Accordingly, the appended claims are intended to include within their scope such processes, machines, manufacture, compositions of matter, means, methods, or steps.

The present invention may suitably comprise, consist or consist essentially of the elements disclosed and may be practiced in the absence of an element not disclosed. Furthermore, if there is language referring to order, such as first and second, it should be understood in an exemplary sense and not in a limiting sense. For example, it can be recognized by those skilled in the art that certain steps can be combined into a single step or reversed in order.

The singular forms “a”, “an” and “the” include plural referents, unless the context clearly dictates otherwise.

“Comprising” in a claim is an open transitional term which means the subsequently identified claim elements are a nonexclusive listing (i.e., anything else may be additionally included and remain within the scope of “comprising”). “Comprising” as used herein may be replaced by the more limited transitional terms “consisting essentially of” and “consisting of” unless otherwise indicated herein.

“Providing” in a claim is defined to mean furnishing, supplying, making available, or preparing something. The step may be performed by any actor in the absence of express language in the claim to the contrary a range is expressed, it is to be understood that another embodiment is from the one.

Optional or optionally means that the subsequently described event or circumstances may or may not occur. The description includes instances where the event or circumstance occurs and instances where it does not occur.

Ranges may be expressed herein as from about one particular value, and/or to about another particular value. When such particular value and/or to the other particular value, along with all combinations within said range.

All references identified herein are each hereby incorporated by reference into this application in their entireties, as well as for the specific information for which each is cited.

What is claimed is:

1. A method for increasing the available net positive suction head (NPSHa) for a cryogenic pump, wherein the cryogenic pump has a required net positive suction head (NPSHr), the method comprising the steps of:
increasing a pressure within a liquid storage tank to at least a pumping set point, wherein the pumping set point is configured to cause the NPSHa to exceed the NPSHr;
starting the cryogenic pump, thereby sending liquid from within the liquid storage tank through the pump and to an end user;
stopping the cryogenic pump, thereby stopping flow of the liquid from the liquid storage tank; and
resetting the pressure within the liquid storage tank to at least a storage set point.

2. The method of claim 1, wherein the step of increasing the pressure within the liquid storage tank further comprises sending a pressurized gas from an external gas source into a headspace of the liquid storage tank.

3. The method of claim 1, wherein the step of increasing the pressure within the liquid storage tank further comprises withdrawing fluid from the liquid storage tank and introducing said liquid into a pressure building unit that is configured to increase the pressure of the fluid, and then introducing said fluid at an increased pressure to the liquid storage tank, thereby increasing the pressure within the liquid storage tank.

4. The method of claim 1, further comprising the step of cooling the cryogenic pump prior to the step of starting the cryogenic pump.

5. The method of claim 1, further comprising the step of further maintaining the pressure within the liquid storage tank at the pumping set point while the cryogenic pump is operating in order to compensate for head losses due to lower liquid levels.

6. The method of claim 1, further comprising the step of measuring a liquid level within the liquid storage tank.

7. The method of claim 6, further comprising the step of immediately increasing the pressure within the liquid storage tank upon a determination that the liquid within the liquid storage tank is below a liquid level threshold.

8. The method of claim 1, wherein the step of resetting the pressure within the liquid storage tank comprises venting gas from a headspace of the liquid storage tank after stopping the cryogenic pump.
